(19) United States
(12) Patent Application Publication
(10) Pub. No.: US 2010/0014658 A1
(43) Pub. Date: Jan. 21, 2010

(54) METHOD OF CUSTOMIZING A SECURITY COMPONENT, NOTABLY IN AN UNPROTECTED ENVIRONMENT

(75) Inventors: Thierry D'athis, Versaillles (FR); Philippe Dailly, Etrechy (FR); Denis Ratier, Draveil (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/438,897

(22) PCT Filed: Aug. 24, 2007
(86) PCT No.: PCT/EP07/58834

§ 371 Date: Aug. 19, 2009

(30) Foreign Application Priority Data
Aug. 25, 2006 (FR) 0607524

(51) Int. Cl. H04L 9/28

(52) U.S. Cl. 380/28

(57) ABSTRACT

The invention relates to a method of customizing a security component in an unprotected environment. The method according to embodiments of the invention includes: inserting a first secret K0 into said security component, said insertion implemented in a secure domain under the responsibility of the manufacturer of the security component; generating an application secret K and generating a customization cryptogram [K]K0 obtained by encrypting the application secret K with the first secret K0, in an application secure domain under the responsibility of the holder of the security component; and customizing the security component by inserting the customization cryptogram [K]K0 into said security component, said customization step being implemented in an application domain. The invention applies to components of secure access module type.

### CROSS-REFERENCE TO PRIOR APPLICATION

This is a U.S. National Phase application under 35 U.S.C. §371 of International Application No. PCT/EP2007/0588354, filed Aug. 24, 2007, and claims benefit of French Patent Application No. 0607524, filed Aug. 25, 2006, both of which are incorporated herein. The International Application was published in French on Feb. 28, 2008 as WO 2008/023065 under PCT Article 21(2).

### BACKGROUND OF THE INVENTION

The invention relates to a method of customizing or initializing a security component in an unprotected environment. In particular, the invention applies to components of secure access module type (also known as a Security Access Module).

### BRIEF DESCRIPTION OF THE PRIOR ART

Components of secure access module type are used in numerous systems, for example within ticketing systems. These systems implement, with the aid of these components, cryptographic methods fulfilling notably functions for encryption/decryption, authentication, affixing signatures, etc. These various cryptographic methods, whatever the technology employed, need, at least in their initialization phase, a first secret (symmetric key, asymmetric key, random number etc.). Now, the security level of the security functions of the system depends on the level of confidentiality of this first secret. Specifically, the compromising of this first secret generally gives rise to a loss of confidence in relation to the whole security chain dependent on this first secret.

The introduction of a first secret into a security component is generally accomplished by the manufacturer of said component. This operation is generally carried out on a mass-produced batch of security components. Then, the first secret is transmitted to the buyer of the security component batch. Based on the knowledge of this first secret, the buyer generally wishes to customize the first secret for each component by introducing a customized secret into each component. This step makes it possible to significantly improve the security of the system, notably by generating a secret known to the buyer alone. But this step comes up against the knowledge of the first secret, since it is not possible to introduce a customized secret without the knowledge of the first secret. It follows that the introduction of the customized secret must be carried out in a domain that is secure in relation notably to personnel who can access the components in the course of this step. Thus, the components are generally customized in secure premises.

For a complete system, for example a ticketing system, which can include a significant number of devices comprising security components, distributed over a significant geographical zone, this customization step therefore turns out to be long, expensive and rather inflexible. This drawback is particularly noticeable during the deployment of such a system.

### SUMMARY OF THE INVENTION

A French patent application (FR2873467A) describes a method of customizing secure electronic elements by replacing a first native secret key with a second secret key generated by an authentication module on the basis notably of the first secret key.

The aim of the invention is notably to alleviate the aforesaid drawbacks. The subject of the invention is a method of customizing a security component, embodiments of which include:
a step of inserting a first secret K0 into said security component, said step being implemented in a secure domain under the responsibility of the manufacturer of the security component
a step of generating an application secret K and a step of generating a customization cryptogram [K]K0 obtained by encrypting the application secret K with the first secret K0, said steps being implemented in an application secure domain under the responsibility of the holder of the security component;
a step of customizing the security component by inserting the customization cryptogram [K]K0 into said security component, said customization step being implemented in an application domain.

Advantageously, the method can furthermore include a step where the first secret K0 is inserted into an encryption component, said step being implemented in the secure domain under the responsibility of the manufacturer of the security component. The encryption component is used to encrypt the application secret K with the first secret K0 to generate the customization cryptogram [K]K0.

In one embodiment, the number of possible uses of the encryption component is limited.

In another embodiment, a first diversified secret K0_{ND} is inserted into said security component. The first diversified secret K0_{ND} is obtained by encrypting an information ND specific to the security component with the aid of a master secret KM. The application secret K is inserted in the step of customizing the security component by loading the customization cryptogram [K]K0_{ND}. The information ND can be the serial number NS of the security component, or derived from the serial number NS and/or an irreversible uses counter N.

Advantageously, the function for loading the application secret K into the mass-produced security component is irreversible.

Embodiments of the invention notably have the advantages that it enables the sensitive data loaded in a security component to remain confidential at any moment:

in relation to any person outside the system, even hostile, and present during the customization operation;

in relation to any person operating the customization, be it an administrator or simple agent;

in relation to any person inside the application system (designer, developer, etc.).

Furthermore, the customization of the components is performed without any need for external connection. The confidential data can be protected from cloning, a cloning operation consisting in replaying the exchanges on another component of the same type. The confidential data can be protected from replay on the same component.

### BRIEF DESCRIPTION OF THE DRAWINGS

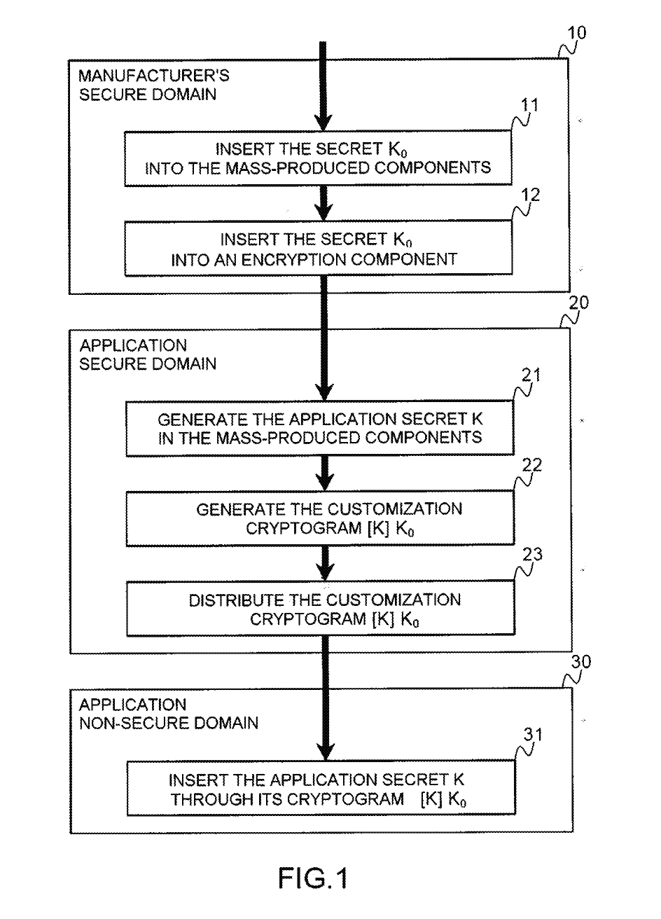

Other characteristics and advantages of embodiments of the invention will become apparent with the aid of the description which follows given with regard to the appended drawings which represent, FIG. 1, a schematic of the method according to embodiments of the invention for customizing a security component in an unprotected environment.

### DETAILED DESCRIPTION

FIG. 1 illustrates through a schematic the method according to the invention for customizing a security component in an unprotected environment. The object of the method according to the invention is notably to bring to a security component an application secret K, which can be manufactured and used only with the aid of a first secret K0 obtained from a trusted third party. The trusted third party is, for example, the manufacturer of the component himself. The security component is, for example, of secure access module type (or SAM type, the acronym standing for Security Access Module).

Thus, in a step 11, the manufacturer inserts the first secret K0 into the security component. The first secret K0 can be inserted physically into the electrical circuit of the security component or into the microprogram of the security component (or firmware, as it is known). In the course of this step 11, the first secret K0 can be inserted into a significant number of security components forming one or more batches, mass-produced.

In a step 12, the manufacturer can insert the first secret K0, used notably in step 11, into an encryption component, so as to have available a secure means making it possible to distribute the first secret K0 to the buyer of the security component. The encryption component is a means suitable for generating the application secret K with the aid of its secret K0. For all that, ideally, the encryption component does not offer any means of access to the first secret K0 or limits access thereto by making understanding or physical access difficult. For example, the encryption component suitable for generating the application secret K can be a security component of secure access module type, capable of coding any value with the first secret K0, which is non-extractable. Thus, inserting the first secret K0 into the encryption component enables the manufacturer of the component to no longer necessarily have to keep secrets other than the secret K0. Specifically, the encryption component is delivered on completion of step 12 to the buyer of the series of security components enclosing the first secret K0 on completion of step 11. The buyer will then be able to generate a customization cryptogram [K]K0 from the first secret K0 based on an application secret K.

The operations conducted within steps 11 and 12 are carried out in a secure domain 10 under the responsibility of the manufacturer of the security component. Specifically, the discovery of the first secret K0 by an attacker would enable him to find the application secret K by monitoring the cryptogram [K]K0. This is why the secret K0 should not be known outside of the secure domain 10 under the responsibility of the manufacturer. Furthermore, the manufacturer should be trusted to guarantee the security of the systems implementing said security components. The encryption component is sensitive since it holds the secret K0 of the manufacturer on the one hand, and on the other hand, it may undergo an attack consisting in discovering the application secret K. Specifically, using the encryption component in decryption would make it possible to discover the application secret K based on the knowledge of the cryptogram [K]K0, even without knowing the first secret K0. For this reason, the encryption component shouldbe protected by authorizing the use of the encryption function and by forbidding the use of the decryption function. In one embodiment, attack of the encryption component can be rendered more difficult by limiting the number of possible uses of the encryption component. This limitation can be introduced by the manufacturer of the encryption component.

In a step 21, the application secret K is generated. Then in a step 22, the customization cryptogram [K]K0 is generated. The customization cryptogram corresponds to the encryption of the application secret K application generated in step 21 by the first secret K0. The customization cryptogram [K]K0 is obtained by using the encryption component to encrypt the secret K with the aid of the first secret K0. The customization cryptogram [K]K0 does not necessarily have to be kept secret. The customization cryptogram [K]K0 is thereafter distributed in a step 23 to other persons, for example to persons in charge of the deployment of the system.

The operations conducted within steps 21, 22 are carried out in an application secure domain 20 within the province of the holder of the security components. These operations shouldbe carried out in a secure framework: for example, they can be conducted in a phase of system parameterization in secure premises.

Next, in a step 31, the security component is customized by inserting the customization cryptogram [K]K0 generated in step 22 and distributed in step 23 outside the application secure domain 20. The security component then includes the customization cryptogram [K]K0 as well as the first secret K0 inserted by the constructor in step 11. Thus, the security component obtains the knowledge of the application secret K.

The operations conducted within step 31 are carried out in an application non-secure domain 30. These operations do not necessarily have to be carried out in a secure framework: for example, they can be conducted in a phase of installing a system in an arbitrary place without specific monitoring.

In one embodiment, an anti-cloning function is implemented in the security component. The first secret K0 included in the security components of one or more mass-produced batches is diversified so as to guarantee a security level suited to the requirement of the system. So, in order to introduce a different first secret for each security component included in the various batches and to avoid manufacturing as many encryption components as security components, it is necessary to generate first secrets obtained by diversification of a master secret KM. Thus the procedure for generating the first secrets obtained by diversification of the first secret K0 should be deterministic. For this purpose, each mass-produced security component is manufactured with a first diversified secret K0_{ND} obtained by encrypting an information ND (Diversifying Number) with the secret KM, i.e. K0_{ND}=[ND]KM. The information ND can be the serial number NS of the security component. The first diversified secret K0_{ND} can be obtained with the aid of a single encryption component for all the security components of the various batches. The application secret K is thereafter inserted in step 31 by loading the customization cryptogram [K]K0_{ND}. It will be possible to use the customization cryptogram [K]K0_{ND} to load the application secret K only onto the security component whose diversifying number is equal to the information ND.

In one embodiment, an anti-replay function is implemented in the security component. For example, the command to reload the application secret K into the series security component is irreversible. Furthermore, the N+1^{st} loading of the secret K, denoted K_{N+1}, can be forced to depend on the secret K_{N}, or on the secret K0 modified by the value N (for example [N]K0), the component then using an irreversible counter of uses containing the value N. It is therefore impossible to restore the security component to the factory state.

These two embodiments, the diversification of the first secret K0 and the anti-replay function, can be combined, thus enabling the loading of the secret K_{N+1} to be made to depend on the secret [ND]K_{N}, on the secret [N]K0_{ND}, or on any other combination of ND, NS, N, K_{N} and K0_{ND} varying from one component to another and from one loading to another.

1-6. (canceled)

7. A method of customizing a security component, comprising:
inserting a first secret into said security component, said step being implemented in a secure domain under a responsibility of a manufacturer of the security component;
inserting the first secret into an encryption component, said step being implemented in the secure domain under the responsibility of the manufacturer of the security component;
generating an application secret in an application secure domain under the responsibility of a custodian of the security component;
enciphering the application secret with the first secret by use of the encryption component, in the application secure domain under the responsibility of the custodian of the security component, to generate a customization cryptogram; and
inserting the customization cryptogram into said security component, said step of inserting the customization cryptogram being implemented in an application domain, to customize the security component.

8. The method as claimed in claim 7, wherein a number of possible uses of the encryption component is limited.

9. The method as claimed in claim 7, further comprising the step of:
enciphering a cue specific to the security component with use of a master secret, to produce the first secret.

10. The method as claimed in claim 9, wherein the cue includes a serial number of the security component, or derived from the serial number and/or a counter of irreversible uses.

11. The method as claimed in claim 7, wherein a function for loading the application secret into the security component is irreversible.
